(19) United States
(12) Patent Application Publication
(10) Pub. No.: US 2026/0081731 A1
(43) Pub. Date: Mar. 19, 2026

(54) UNEQUAL MODULATION PHY LAYER SIGNALING FOR WIFI SYSTEM

(71) Applicant: InterDigital Patent Holdings, Inc., Wilmington, DE (US)

(72) Inventors: Hanqing Lou, Syosset, NY (US); Ying Wang, Easton, PA (US); Rui Yang, Greenlawn, NY (US)

(73) Assignee: InterDigital Patent Holdings, Inc., Wilmington, DE (US)

(21) Appl. No.: 18/884,773

(22) Filed: Sep. 13, 2024

(51) Int. Cl. H04L 5/00; H04W 80/04

(52) U.S. Cl. CPC H04L 5/0025; H04L 5/0048; H04W 80/04

(57) ABSTRACT

A first station (STA) may receive a physical protocol data unit (PPDU) including user fields associated with the spatial streams of a plurality of stations (STAs). Each of the user fields may include: an indication of a STA identifier (ID), an indication of a spatial stream index, and an indication of a modulation and coding scheme (MCS) of the respective spatial stream of the respective STA. The first STA may determine, based on the indicated STA IDs one or more user fields intended for the first STA. The first STA may determine, for each of the spatial streams of the first STA, an MCS value based on the indicated MCS in the user field intended for the first STA. The first STA may decode the spatial streams intended for the first STA according to the determined MCS values using one or more resource units (RUs) or multiple resource units (MRUs).

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is peer-to-peer traffic, which may also be sent directly between the source and destination STAs with a direct link setup (DLS) using an 802.11e DLS or an 802.11z tunneled DLS (TDLS). A WLAN using Independent BSS (IBSS) mode has no AP, and the STAs using such an IBSS may communicate directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the occupancy or vacancy of the primary channel. If the channel is detected to be busy, the STA backs off. Hence only one STA may transmit at any given time, frequency, and space resources in each BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz and 80 MHz channels are formed by combining contiguous 20 MHz channels as described above for 802.11n. A 160 MHz channel may be formed either by combining 8 contiguous 20 MHz channels, or by combining two non-contiguous 80 MHz channels, which may be referred to as an 80+80 configuration. For the 80+80 configuration, at the transmitter, the data, after channel encoding, may be passed through a segment parser that divides the data into two streams. Inverse fast Fourier transform (IFFT) and time domain processing are done on each stream separately. The two streams are then mapped onto the two 80 MHz channels for transmission. At the receiver, this mechanism is reversed, and the combined data from the two 80 MHz channels is sent to the medium access control (MAC) layer.

In 802.11ax, High Efficiency (HE) Wireless STAs may support 20 MHz, 40 MHz, 80 MHz, and/or 160 MHz wide channels capable of transmission over 2.4 GHZ, 5 GHZ, and 6 GHz frequency bands using both orthogonal frequency-division multiple access (OFDMA) and multi-user multiple-input multiple-output (MU-MIMO) capabilities. OFDMA subcarrier modulation in HE STAs includes formats such as BPSK, QPSK, 16-QAM, 64-QAM, 256-QAM, and 1024-QAM. The evolution of 802.11 to Extremely High Throughput (EHT, or 802.11be) STAs extends to having 320 MHz wide channels.

Sub 1 GHz modes of operation are supported by 802.11af and 802.11ah. For these specifications the channel operating bandwidths, and the number of Orthogonal frequency-division multiplexing (OFDM) subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel is therefore limited by the STA that supports the smallest bandwidth operating mode in the BSS. In the example of 802.11ah, the primary channel may be 1 MHz wide if there are STAs (e.g. MTC type devices) that only support a 1 MHz mode even if the AP, and other STAs in the BSS, may support 2 MHz, 4 MHz, 8 MHz, 16 MHz, or other channel bandwidth operating modes. All carrier sensing and NAV settings depend on the status of the primary channel, i.e., if the primary channel is busy, for example, due to a STA supporting only a 1 MHz operating mode is transmitting to the AP, then the entire available frequency bands are considered busy even though majority of it stays idle and available.

To improve spectral efficiency, 802.11n started to introduce the multiple-input multiple-output (MIMO) technology, which multiplies capacity by transmitting up to 4 spatial streams (or data streams) over different antennas. 802.11ac further introduced downlink multi-user MIMO (MU-MIMO) transmission, where multiple users may send their spatial streams (max 4 per user, total up to 8) over different antennas simultaneously on the same frequency, i.e., on the same OFDM subcarrier and in the same OFDM symbol. 802.11ax and 802.11be use both orthogonal frequency-division multiple access (OFDMA), which is multiplexing users in the frequency domain, and UL/DL MU-MIMO, which is multiplexing users in the spatial domain.

The IEEE 802.11 Ultra High Reliability (UHR), or 802.11bn, Study Group was formed in September 2022. UHR is considered as the next major revision to IEEE 802.11 standards following 802.11be (or EHT), which is currently in the Working Group Letter Ballot Stage. UHR explores the possibility to improve reliability, support further reduced low latency traffic, further increase peak throughput, improve power saving capabilities, and improve efficiency of the IEEE 802.11 network over EHT.

### SUMMARY

Example embodiments include signaling procedures to indicate modulation order per spatial stream and/or frequency segment in a physical protocol data unit (PPDU), which may be used for unequal modulation (UQEM) for a single user. Example procedures may be performed by a first STA that is an intended recipient of a PPDU and uses the information in the PPDU to receive and decode a plurality of spatial streams over resource units (RUs)/multiple resource units (MRUs) according to the information in the received PPDU. The data of the spatial streams may be carried in the data field of the received PPDU. The first STA may receive a PPDU comprising a SIG field, the SIG field comprising a plurality of user fields associated with a respective plurality of spatial streams of a plurality of stations STAs. Each of the plurality of user fields may include: an indication of a STA identifier (ID) of a respective STA, an indication of a spatial stream index of the respective STA, and an indication of a modulation and coding scheme (MCS) of the respective spatial stream of the respective STA. In an example, a first user field may indicate the first STA, a first spatial stream of the first STA (e.g., spatial stream with index ‘1’), and a first MCS associated with the first spatial stream of the first STA. A second user field may indicate the first STA, a second spatial stream of the first STA (e.g., spatial stream with index ‘2’), and a second MCS associated with the second spatial stream of the first STA, such that the first MCS associated with the first spatial stream of the first STA and the second MCS associated with the second spatial stream of the first STA include different modulation orders. A third user field may indicate a second STA, a first spatial stream of the second STA (e.g., spatial stream with index ‘1’), and a first MCS associated with the first spatial stream of the second STA. A fourth user field may indicate the second STA, a second spatial stream of the second STA, and a second MCS associated with the second spatial stream of the second STA (e.g., spatial stream with index ‘2’), such that the first MCS associated with the first spatial stream of the second STA and the second MCS associated with the second spatial stream of the second STA include different modulation orders.

The first STA may determine, based on the indicated STA IDs in the plurality of user fields, one or more user fields intended for the first STA, wherein the number of user fields intended for the first STA corresponds to the number of spatial streams of the first STA. The first STA may determine, for each of the spatial streams of the first STA, an MCS value based on the indicated MCS in the user field intended for the first STA for the respective spatial stream according to the indicated spatial stream index. The first STA may decode the spatial streams intended for the first STA according to the determined MCS values using one or more resource units (RUs) or multiple resource units (MRUs). Decoding the spatial streams intended for the first STA involves decoding the data field carried in the PPDU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a frame format diagram illustrating an example UHR PPDU format;

FIG. 2B is a frame format diagram illustrating an example UHR-SIG field format, which may be included in the UHR PPDU of FIG. 2A;

FIG. 3 is a frame format diagram illustrating an example UHR PPDU format including user fields that are associated with spatial streams to enable UEQM in the spatial domain;

FIG. 4 is a frame format diagram illustrating an example UHR PPDU format including user fields that are associated with RUs/MRUs to enable UEQM in the frequency domain;

FIG. 5 is a frame format diagram illustrating an example user field format for RUs/MRUs with EQM, which may be included in a UHR PPDU;

FIG. 6 is a frame format diagram illustrating an example user field format for RUs/MRUs with UEQM, which may be included in a UHR PPDU;

FIG. 7 is a flow diagram illustrating an example procedure for signaling modulation order in a PPDU in the case of UEQM in the spatial domain;

FIG. 8 is a frame format diagram illustrating an example user field format for RUs/MRUs with EQM and UEQM, which may be included in a UHR PPDU; and

FIG. 9 is a frame format diagram illustrating an example spatial/modulation configuration subfield 900 format that may be included in a user field of a PPDU of FIG. 8.

### DETAILED DESCRIPTION

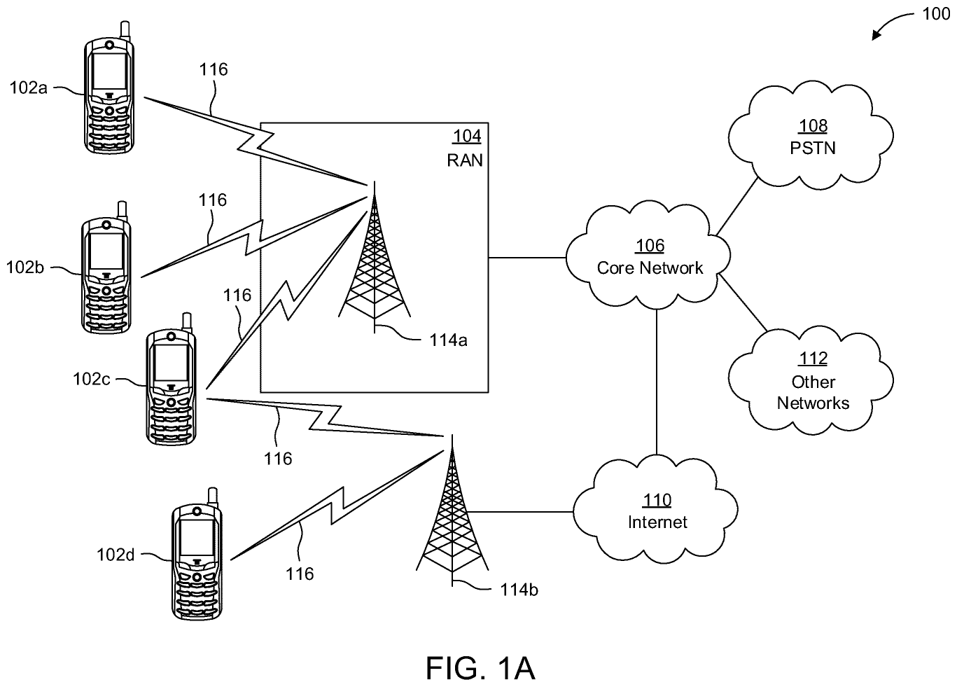

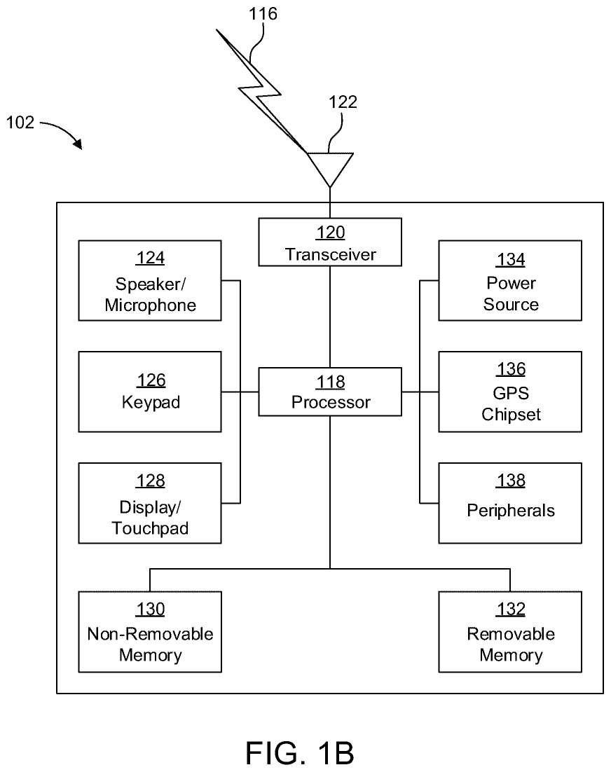

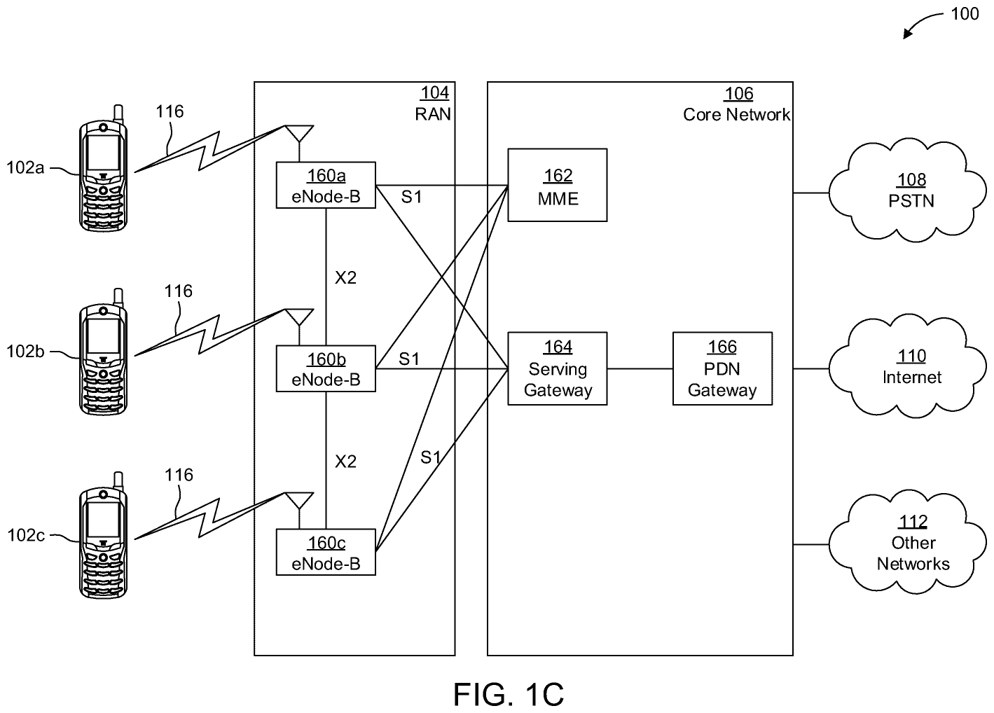

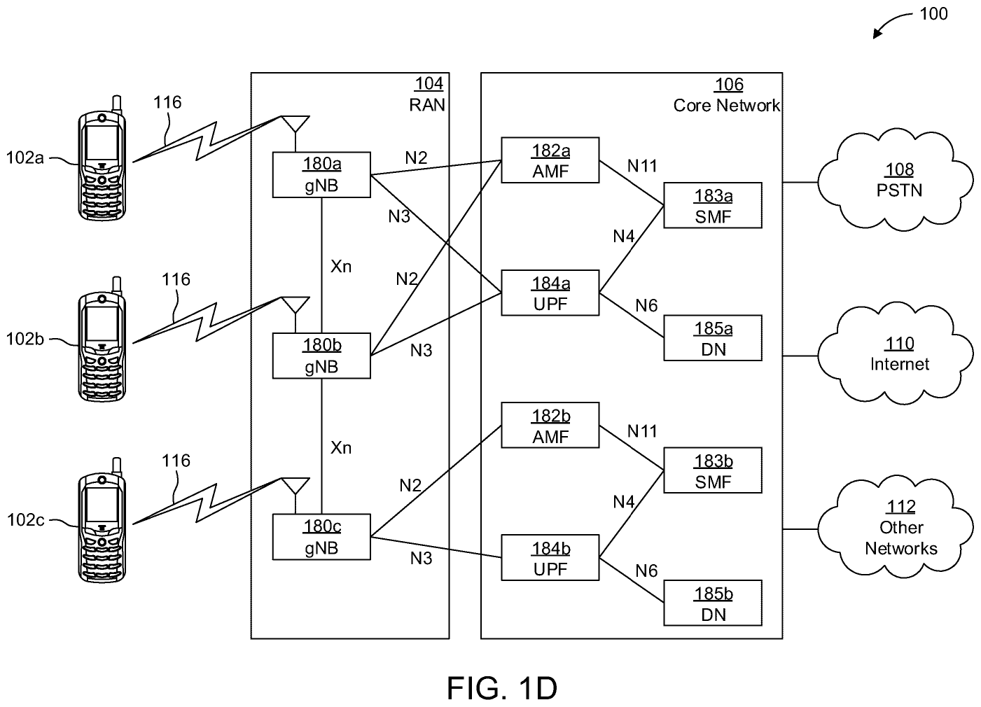

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (and/or a “STA”), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to, for example, facilitate access to one or more communication networks, such as the CN 106, the Internet 110, and/or the other networks 112. By way of example, the base stations 114a, 114b may be a base transceiver station (BTS), a Node B, an eNode-B (eNB), a Home Node-B (HNB), a Home eNode-B (HeNB, a next generation Node-B (NR NB), such as a gNode-B (gNB), a new radio (NR) Node-B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, the gNBs 180a, 180b, 180c may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability (UHR)) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

Unequal modulations among multiple spatial streams are supported in 802.11bn. The signaling to indicate the modulation order per spatial stream is needed. With downlink (DL) transmission, and single user (SU) uplink (UL) transmission, the intended receivers need to know the modulation order of each spatial stream and/or frequency segment to decode a received signal. Therefore effective signaling of modulation order in the DL PPDU or single user UL PPDU is needed. Example embodiments disclosed herein provide signaling methods and procedures to indicate the modulation order per spatial stream and/or frequency segment may apply to 802.11 wireless communications systems, including 802.11bn. Example embodiments may apply to unequal modulation (UEQM) over different modulations and/or different frequency segments (e.g., RU(s), MRU(s), equal modulation (EQM) combined with UEQM, physical layer (PHY) protocol data unit (PPDU) design, per spatial stream user field in a signal field (e.g., UHR-SIG field) of a PPDU, and/or multiple modulation orders in user field(s) of a PPDU. Herein, PPDU, frame, and message may be used interchangeably. Herein, spatial stream and may be used interchangeably. Herein, tone and subcarrier may be used interchangeably, and data tone and data subcarrier may be used interchangeably. An X-tone RU may have a total number of X tones, including both data tones and pilot tones. When a data bit sequence is assigned to a RU, the bits may be allocated to the data tones (i.e., data subcarriers) only. Herein, STA and user may be used interchangeably.

It may be appreciated that one or more fields of a frame described and illustrated in the context a particular 802.11 amendment, may also apply to different and/or future 802.11 amendments based on having the same functionality. For example, the present disclosure refers to a UHR SIG field having different fields such as a UEQM field. It is therefore contemplated that the same UEQM field or another field having the same functionality as the UEQM field may be present in a field/frame of a future 802.11 amendment. A UEQM field or a functional equivalent of the UEQM field in the current UHR-SIG, may be found in, for example, future SIG field(s).

In an example embodiment, signaling is defined for UEQM among spatial streams such that a transmitter may inform the receiver of the modulation order for each spatial stream. The signaling for UEQM among spatial streams may be carried, for example, in the preamble of a frame or anywhere else in the frame.

In an example, UEQM may be allowed for a set of RUs/MRUs. For example, UEQM may be allowed for large RUs/MRUs. For example, UEQM may be allowed for RUs/MRUs with sizes (e.g., in terms of number of tones) larger than or equal to a specific threshold (e.g., a threshold of 242 tones). In another example, the UEQM may be allowed for small RUs/MRUs. For example, UEQM may be allowed for RUs/MRUs with sizes less than or equal to a specific threshold (e.g., 242 tones).

In an example, a PPDU may allow either UEQM per user or equal modulation (EQM) per user, but may not allow both UEQM and EQM per user. A UEQM enabled PPDU may be defined as a PPDU where all the user fields in a signal (SIG) field (e.g., UHR-SIG field) may be able to indicate the per spatial stream modulation order. In another example, a hybrid PPDU with allow UEQM per user and EQM per user. In this case, a UEQM enabled PPDU may be defined as a PPDU where at least one user field in a SIG field (e.g., UHR-SIG field) may be used to indicate the per spatial stream modulation order.

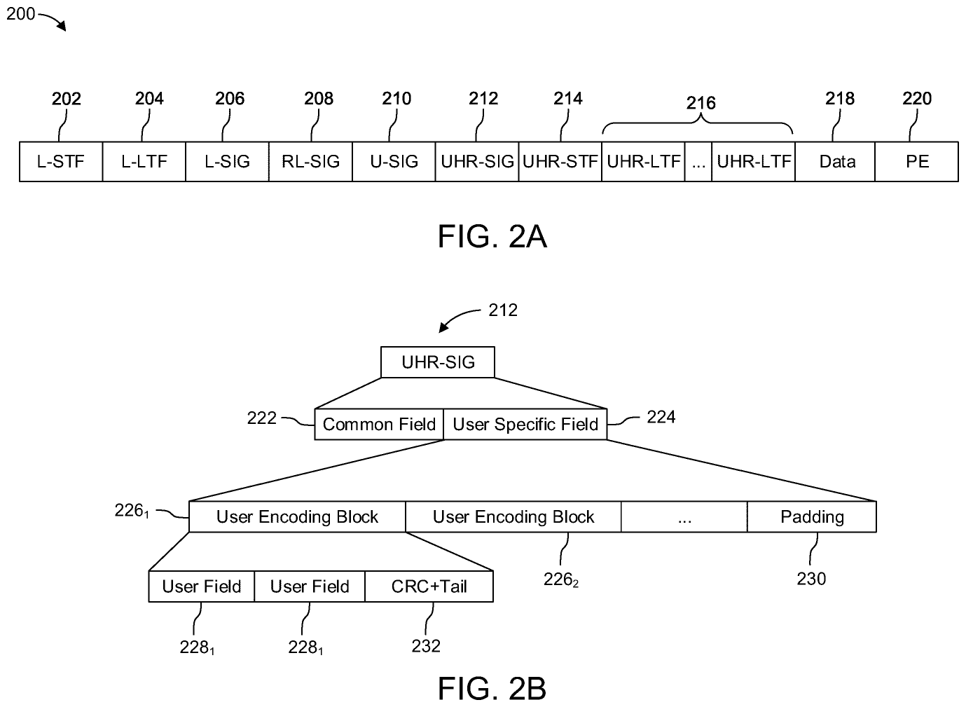

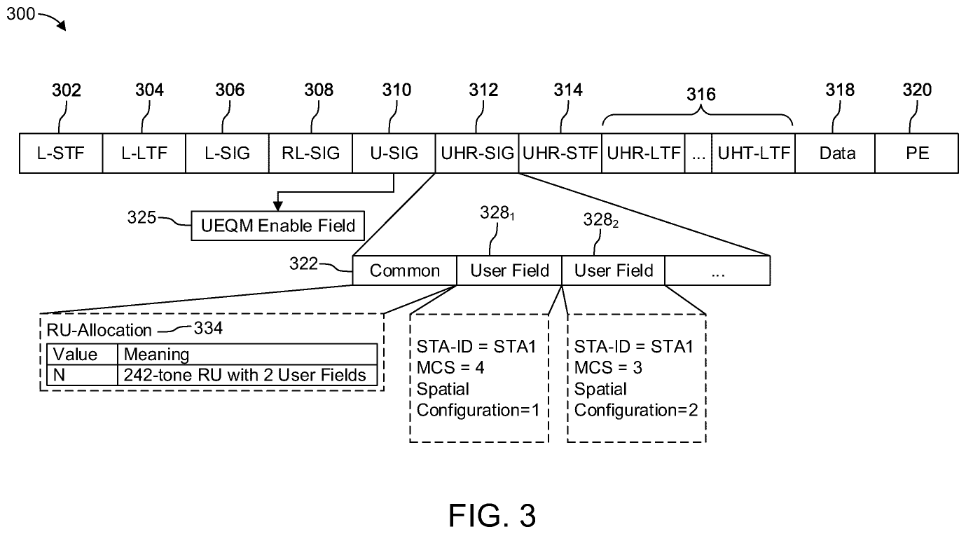

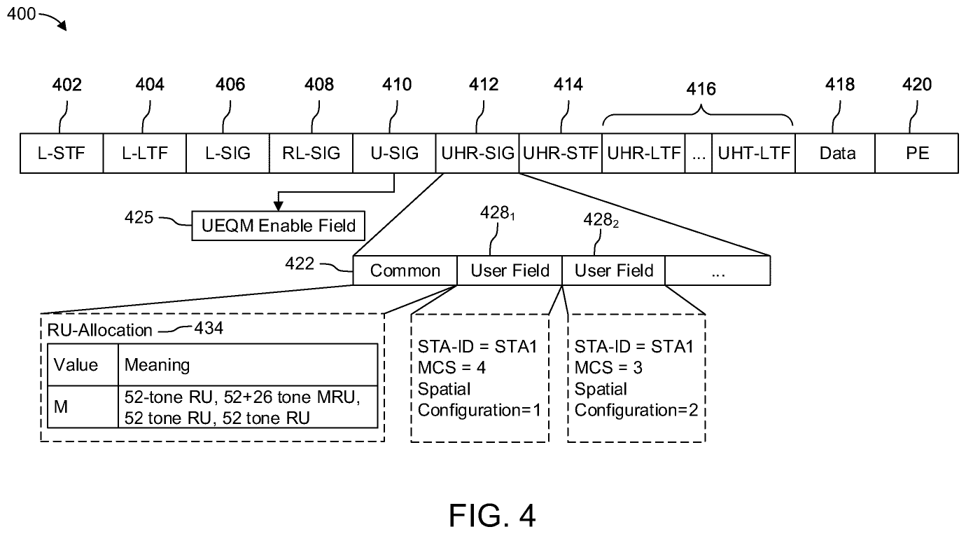

FIG. 2A is a frame format diagram illustrating an example UHR PPDU 200 format. The UHR PPDU 200 may include (e.g., as part of a preamble) any one or more of the following fields: legacy short training field (L-STF) field 202, legacy long training field (L-LTF) field 204, legacy signal (L-SIG) field 206, repeated L-SIG (RL-SIG) field 208, universal signal (U-SIG) field 210, UHR signal (UHR-SIG) field 212, UHR short training field (UHR-STF) field 214, and a plurality of UHR long training fields (UHR-LTF) fields 216. The UHR PPDU 200 may further include data field(s) 218, and packet extension (PE) field(s) 220. Some fields shown may not be included, for example depending on the detailed type of the PPDU, and other fields not shown may be present. In an example embodiment, an UEQM enabled field (as shown in FIGS. 3 and 4) may be included in the U-SIG field 210 or UHR-SIG field 212 to indicate that UEQM may be enabled in the PPDU 200. When the UEQM enabled field is set to true (e.g., ‘1’ or ‘0’), then it may imply that one or more user fields in the UHR-SIG field 212 may carry per spatial stream or per RU modulation order/size. In another example, an indicator field within a field shown in FIG. 2A may be used to indicate UEQM is enabled in the PPDU 200. For example, the PPDU type field (not shown) in the U-SIG field 210 may be set to a specific value to indicate (e.g., ‘1’ or ‘0’) that the PPDU 200 is a UEQM enabled PPDU.

A UHR-SIG field of a PPDU may include a common field and a user specific field. The common field may include one or more RU allocation subfields. The RU allocation subfields may indicate information compute the number of users and/or number of user fields allocated to each of the RU(s) or MRU(s) in the RU allocation. The user specific field may include zero, one or more user fields. Each user field may include information such as station identity (STA ID), modulation and coding scheme (MCS) (i.e., information indicating a modulation order and/or channel coding rate of an RU/MRU). In example embodiments described hereinafter, the user specific field may be modified to include information on the per spatial stream modulation order.

In an example embodiment, per spatial stream user fields may be included in an UHR-SIG of a UHR PPDU to convey UEQM modulation order information on a per spatial stream basis. FIG. 2B is a frame format diagram illustrating an example UHR-SIG field 212 format, which may be included in the UHR PPDU 200 of FIG. 2A. The UHR-SIG field 212 may include a common field 222 and a user specific field 224. The user specific field 224 may include one or more user encoding blocks 226₁, 226₂, . . . . Each user encoding block 226₁, 226₂, . . . may include two user fields 2281, 2282 except the a user encoding block 226ₓ that may contain one or two user fields 228₁, 228₂. Each user encoding block 226₁, 226₂, . . . may be encoded separately, and thus CRC and Tail bits 232 may be added to each user encoding block 226₁, 226₂, . . . .

The common field 222 may include one or more RU allocation fields (not shown). The RU allocation field may include information to partition a frequency block or subblock into RUs/MRUs. The RU allocation fields included in the UHR-SIG field 212 may indicate the number of user fields 228₁, 228₂ and/or the number of users signaled in the frequency subblock. The RU Allocation field may be a lookup table where each entry may represent a way to partition the frequency block/subblock. For example, a first entry in the lookup table may represent partitioning a 20 MHz subblock into 9 RUs and each RU has 26 tones. A second entry may represent partitioning a 20 MHz subblock into 4 RUs/MRUs: 52-tone RU, 52+26 tone MRU, 52 tone RU, and 52 tone RU. In an example scenario, multiple entries in the lookup table may represent the same RU/MRU but different entries may correspond to different numbers of user fields. For example, entry N to entry N+7 may represent a 242-tone RU that occupies the entire 20 MHz subblock. There may be eight entries corresponding to this RU and each entry may indicate a different number of user fields associated with the RU. For example, entry three in the lookup table may refer to a 242-tone RU with one user field. Entry four in the lookup table means a 242-tone RU with 2 user fields.

In an example embodiment, each user field within a UHR-SIG field of a UHR PPDU may correspond to a spatial stream of a user. In another word, the information carried in each user field may be applied to a spatial stream of a user, such that a user may have one or more associated spatial stream and thus one or more associated user field in the UHR PPDU. In the case that a user has multiple associated spatial stream, then the user will have multiple user fields. An example is shown in FIG. 3. FIG. 3 is a frame format diagram illustrating an example UHR PPDU 300 format including user fields 328₁, 328₂, . . . that are associated with spatial streams to enable UEQM in the spatial domain, in accordance with embodiments disclosed herein. The UHR PPDU 300 may include (e.g., as part of a preamble) any one or more of the following fields: L-STF field 302, L-LTF field 304, L-SIG field 306, RL-SIG field 308, U-SIG field 310, UHR-SIG field 312, UHR-STF field 314, and a plurality of UHR-LTF fields 316. The UHR PPDU 300 may further include data field(s) 318, and packet extension (PE) field(s) 320. Some fields shown may not be included, for example depending on the detailed type of the PPDU, and other fields not shown may be present. In an example embodiment, an UEQM enabled field 325 may be included in the U-SIG field 310 (or UHR-SIG field 312) to indicate that UEQM is enabled in the PPDU 300.

Although not shown in FIG. 3, UHR-SIG field 312 may include user encoding blocks and CRC+tails fields (as shown for example in FIG. 2B). UHR-SIG field 312 may include a common field 322 and multiple user fields 328₁, 328₂, . . . (two user fields are shown for illustration, and the total number of user fields will correspond to total the number of spatial streams across all users). Each user field 328₁, 328₂, . . . may include at least a STA-ID field identifying the intended recipient STA of the information in the respective user field, an MCS field indicating modulation information to be used by the recipient STA for transmission, and a spatial configuration field indicating the spatial stream index for the user (STA) corresponding to the STA-ID that is assigned to use the RU/MRU (and possibly other fields now shown). As indicated by the RU allocation field(s) 334 in common field 322, multiple user fields 328₁, 328₂, . . . may be associated with a same RU/MRU allocation. Each user field 328₁, 328₂, . . . may include at least a STA-ID field, an MCS field, and a spatial configuration field (and possibly other fields now shown). In this example, an RU allocation field 334 in the common field 322 indicates entry with value N, which refers to a 242-tone RU allocation and two user fields 328₁, 328₂ associated with the indicated RU allocation. The user fields 328₁, 328₂ may have the same value indicated in the STA-ID field, for example indicating a STA “STA1”. The spatial configuration field may indicate the first spatial stream index in user field 328₁ and second spatial stream in User field 328₂, respectively. The MCS field in the user field 328₁ may indicate the MCS value for the first spatial stream of STA1 and the MCS field in the user field 328₂ may indicate the MCS value for the second spatial stream of STA1.

The example embodiment described above and illustrated in FIG. 3 may be generalized to enable UEQM in both the spatial domain and frequency domain. In the case that multiple user fields with the same STA-ID value are associated with the same RU/MRU allocation, the signaling method enables UEQM among spatial streams. In the case that the multiple user fields with the same STA-ID value are associated with different RU/MRU allocations, the signaling method enables UEQM among frequency RU/MRUs.

FIG. 4 is a frame format diagram illustrating an example UHR PPDU 400 format including user fields 4281, 4282, . . . that are associated with RUs/MRUs to enable UEQM in the frequency domain, in accordance with embodiments disclosed herein. The number of user fields per user may equal to the number of RUs/MRUs assigned to the user. The UHR PPDU 400 may include (e.g., as part of a preamble) any one or more of the following fields: L-STF field 402, L-LTF field 404, L-SIG field 406, RL-SIG field 408, U-SIG field 410, UHR-SIG field 412, UHR-STF field 414, and a plurality of UHR-LTF fields 416. The UHR PPDU 400 may further include data field(s) 418, and packet extension (PE) field(s) 420. Some fields shown may not be included, for example depending on the detailed type of the PPDU, and other fields not shown may be present. In an example embodiment, an UEQM enabled field 425 may be included in the U-SIG field 410 (or UHR-SIG field 412) to indicate that UEQM is enabled in the PPDU 400.

Although not shown in FIG. 4, UHR-SIG field 412 may include user encoding blocks and CRC+tails fields (as shown for example in FIG. 2B). UHR-SIG field 412 may include a common field 422 and multiple user fields 428₁, 428₂, . . . (two user fields are shown for illustration, and the total number of user fields will correspond to total the number of spatial streams across all users). Each user field 428₁, 428₂, . . . may include at least a STA-ID field identifying the intended recipient STA of the information in the respective user field, an MCS field indicating modulation information to be used by the recipient STA for transmission, and a spatial configuration field indicating the number of spatial streams for the corresponding RU assigned to the corresponding STA. (and possibly other fields now shown). In this example, an RU allocation field 434 in the common field 422 indicates entry with value M to indicate a partition of a 20 MHz frequency subblock into four RUs (52-tone RU, 52+26 tone MRU, 52 tone RU, and 52 tone RU respectively). In this example, four user fields 428₁, 428₂, . . . (only two user fields shown) indicate the detailed assignment for each of the four RUs. User field 428₁ corresponds to a first RU/MRU indicated by the RU allocation field and the User field 428₂ corresponds to a second RU/MRU indicated by the RU Allocation field and so on. In this example, the first two RUs (shown in the figure) are assigned to one STA with STA-ID “STA1”, and therefore the user fields 428₁,428₂ indicate the same value in their STA-ID field (e.g., STA1). In this case, the MCS field in the user field 428₁ indicate the MCS value for the first RU/MRU assigned to STA “STA1” and the MCS field in the user field 428₂ indicates the MCS value for the second RU/MRU assigned to STA “STA1”. In this case, the spatial configuration field in the user field 428₁ may indicate the number of spatial streams for the first RU/MRU assigned to STA “STA1” and the spatial configuration field in the user field 428₂ may indicate the number of spatial streams for the second RU/MRU assigned to STA “STA1”. the number of spatial streams corresponding to different RUs assigned to the same STA (e.g., STA1) may be the same or different.

RU Allocation fields included in the UHR-SIG field may indicate the number of user fields and/or the number of users signaled in the corresponding content channel. However, for the embodiments described herein the number of user fields may not equal to the number of users. A dedicated field or a combination of fields in the U-SIG field or UHR-SIG field may indicate the number of user fields and/or the number of users signaled in the corresponding content channel or the entire bandwidth.

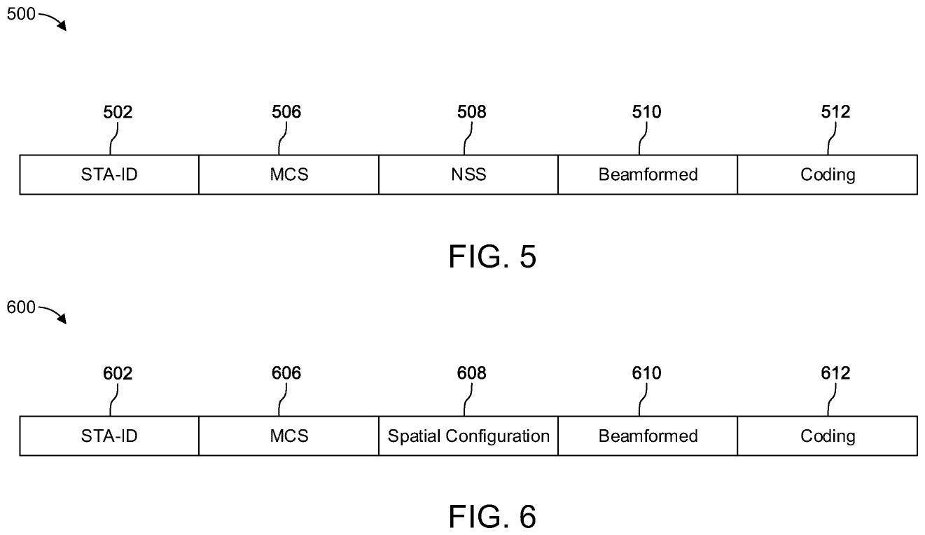

In an example embodiment, for the RUs or MRUs that allow EQM, the corresponding user field format is shown in FIG. 5. FIG. 5 is a frame format diagram illustrating an example user field 500 format for RUs/MRUs with EQM, which may be included in a UHR PPDU, such as the UHR PPDUs described hereinbefore. For a given RU or MRU that may allow EQM (by not UEQM), the number of user fields 500 in the PPDU may be equal to the number of users. The user field 500 may include, but is not limited to include, any of the following fields: STA-ID subfield 502 may indicate the identity of a STA; MCS subfield 506 may indicate the modulation and coding scheme; NSS subfield 508 may indicate the number of spatial streams for the RU/MRU; beamformed subfield 510 may indicate whether beamforming or precoding is applied on the assigned RU/MRU; and/or coding subfield 512 may indicate the coding scheme (e.g., binary convolutional code (BCC) or low-density parity check (LDPC)).

In an example embodiment, for the RUs or MRUs that allow UEQM, the corresponding user field format is shown in FIG. 6. FIG. 6 is a frame format diagram illustrating an example user field 600 format for RUs/MRUs with UEQM, which may be included in a UHR PPDU, such as the UHR PPDUs described hereinbefore. For a given RU or MRU that may allow UEQM, the number of user fields 600 in the PPDU may be equal to the number of spatial streams among all users that share the RU or MRU. The user field 600 may include, but is not limited to include, any of the following fields: STA-ID subfield 602 may indicate the identity of a STA; MCS subfield 606 may indicate the modulation and coding scheme; spatial configuration subfield 608 may indicate the spatial stream index for the user corresponding to the STA-ID which is assigned to use the RU/MRU (described in detail hereinafter); beamformed subfield 610 may indicate whether beamforming or precoding is applied on the assigned RU/MRU; and/or coding subfield 612 may indicate the coding scheme (e.g., BCC or LDPC).

In an example, a spatial configuration subfield in a user field of a PPDU (e.g., spatial configuration subfield 608 in FIG. 6) may include an indication of the number of spatial streams assigned to the user. In an example, an AP may assign two spatial streams to STA1, and the PPDU may include two user fields addressed to STA1. In a first user field, the spatial configuration subfield may indicate that two spatial stream assigned to the STA and the user field is associated with the first spatial stream. In a second user field, the spatial configuration subfield may indicate that two spatial stream assigned to the STA and the user field is associated with the second spatial stream. In an example, the spatial configuration subfield may include a bit to indicate whether this is the last spatial stream assigned to the STA or this is the last user field associated with the STA so that the STA may stop detecting the rest of the UHR-SIG field after the user field. For example, an AP may assign two spatial streams to STA1. The PPDU may have two user field addressed to STA1. In a first user field, the spatial configuration subfield may indicate the user field is associated with the first spatial stream and more user field(s) associated with the STA may follow. In the second user field, the spatial configuration subfield may indicate the user field is associated with the second spatial stream and no more user fields associated with the STA will follow.

In an example, an intended recipient STA that receives a PPDU may decode the UEQM enabled field (e.g., in U-SIG field or UHR-SIG field) and determine, based on an indication by the UEQM enabled field, that the PPDU allows UEQM. By reading the RU allocation fields carried in the UHR-SIG field, the STA may determine that an RU or MRU is associated with more than one user field. If the RU/MRU is allowed to use UEQM, the STA may check the STA-ID field of the user field corresponding to the RU/MRU. The STA may identify a user field for which the STA-ID field match the STA's identity. The STA may use the user field format shown in FIG. 6 to decode the user field. The STA may continue checking subsequent user fields since a user may be associated with multiple User fields.

For the example embodiments described hereinbefore, multiple user fields may have the same STA-ID field to enable multiple RUs/MRUs assigned to a single user. It also enables different MCS assignments for multiple RUs/MRUs assigned to a single user.

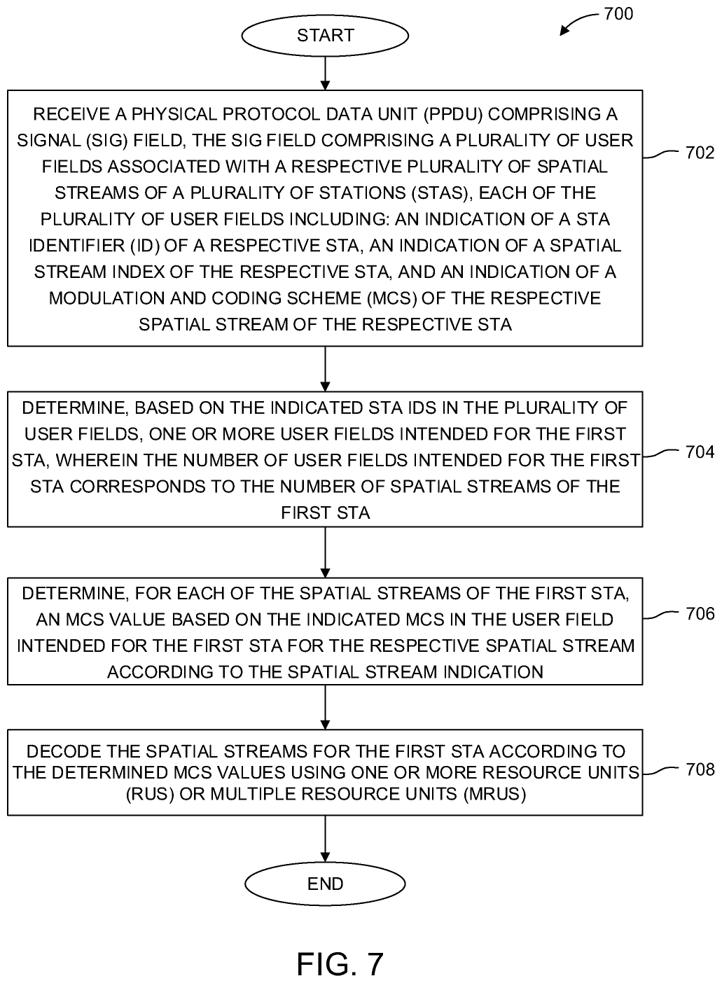

FIG. 7 is a flow diagram illustrating an example procedure 700 for signaling modulation order in a PPDU in the case of UEQM in the spatial domain. Procedure 700 may be performed for example by a first STA that is an intended recipient of a PPDU and uses the information in the PPDU to receive and decode a plurality of spatial streams over RUs/MRUs according to the information in the received PPDU. The data of the spatial streams may be carried in the data field of the received PPDU. At 702, the first STA may receive a PPDU comprising a SIG field, the SIG field comprising a plurality of user fields associated with a respective plurality of spatial streams of a plurality of stations STAs. Each of the plurality of user fields may include: an indication of a STA identifier (ID) of a respective STA, an indication of a spatial stream index of the respective STA, and an indication of a modulation and coding scheme (MCS) of the respective spatial stream of the respective STA. In an example, a first user field may indicate the first STA, a first spatial stream of the first STA (e.g., spatial stream with index ‘1’), and a first MCS associated with the first spatial stream of the first STA. A second user field may indicate the first STA, a second spatial stream of the first STA (e.g., spatial stream with index ‘2’), and a second MCS associated with the second spatial stream of the first STA, such that the first MCS associated with the first spatial stream of the first STA and the second MCS associated with the second spatial stream of the first STA include different modulation orders. A third user field may indicate a second STA, a first spatial stream of the second STA (e.g., spatial stream with index ‘1’), and a first MCS associated with the first spatial stream of the second STA. A fourth user field may indicate the second STA, a second spatial stream of the second STA, and a second MCS associated with the second spatial stream of the second STA (e.g., spatial stream with index ‘2’), such that the first MCS associated with the first spatial stream of the second STA and the second MCS associated with the second spatial stream of the second STA include different modulation orders.

At 704, the first STA may determine, based on the indicated STA IDs in the plurality of user fields, one or more user fields intended for the first STA, wherein the number of user fields intended for the first STA corresponds to the number of spatial streams of the first STA. At 706, the first STA may determine, for each of the spatial streams of the first STA, an MCS value based on the indicated MCS in the user field intended for the first STA for the respective spatial stream according to the indicated spatial stream index. At 708, the first STA may decode the spatial streams intended for the first STA according to the determined MCS values using one or more resource units (RUs) or multiple resource units (MRUs). Decoding the spatial streams intended for the first STA involves decoding the data field carried in the PPDU (e.g., data field 318 in FIG. 3).

In another example method, a first station (STA) may receive, from a second STA, a physical protocol data unit (PPDU) comprising a signal (SIG) field that includes an unequal modulation order (UEQM) field for indicating that an UEQM capability is enabled. The first STA may indicate, from the SIG field, based on the UEQM capability being enabled: a first user field including a first spatial stream and a first modulation and coding scheme (MCS) for a resource unit (RU) or multiple RU (MRU) assigned to the first STA, and a second user field including a second spatial stream and a second MCS for the RU or MRU assigned to the first STA. The first STA may receive, from the second STA, a first PPDU on the first stream based on the first MCS and a second PPDU on the second stream based on the second MCS, wherein the first MCS and the second MCS include different modulation orders.

In an example, the SIG field may comprise a U-SIG field and a UHR-SIG field, the UEQM being located within the U-SIG field or the UHR-SIG field. In an example, the first STA is a non-AP STA and the second STA is an AP STA. In an example, the UEQM field may indicate that the UEQM capability is enabled based on the RU or the MRU being equal to or exceeding a threshold value corresponding to a number of RU or MRU subcarrier tones. In an example, the RU or the MRU may comprise: a first RU or a first MRU associated with the first stream; and a second RU or a second MRU associated with the second stream. In an example, the UEQM field indicates that the UEQM capability is enabled based on: the first RU or the first MRU associated with the first stream having a size equal to or exceeding a threshold value corresponding to a number of RU or MRU subcarrier tones; or the second RU or the second MRU associated with the second stream associated with second first stream having a size equal to or exceeding the threshold value corresponding to the number of RU or MRU subcarrier tones.

In an example, the first user field may comprise first spatial stream information that indicates a first spatial stream index number and a total number of spatial streams associated with the first STA. Based on the first spatial stream index number being equal to the total number of spatial streams, the first STA may stop detecting a remainder of the SIG field following the first user field. The second user field may comprise second spatial stream information that indicates a second spatial stream index number and the total number of spatial streams associated with the first STA. Based on the second spatial stream index number being equal to the total number of spatial streams, the first STA may stop detecting the remainder of the SIG field following the second user field.

In an example, the first user field comprises first spatial stream information that includes a bit for indicating whether the first user field is associated with a last spatial stream assigned to the first STA. Based on the bit being set to zero, the first STA detects the second user field. The second user field comprises second spatial stream information that includes a bit for indicating whether the second user field is associated with the last spatial stream assigned to the first STA. Based on the bit being set to one, the first STA stops detecting a remainder of the SIG field after the second user field. In an example, the first STA may indicate, from the SIG field, an RU allocation field, wherein the RU allocation field informs the first STA that more than one user field comprising the first and the second user fields are associated with the RU or the MRU.

According to another example embodiment, multiple modulation orders may be indicated in a user field, as described in the following. In an example, UEQM may be allowed for SU transmission for both DL and UL, and for DL multiple user transmissions. In an example, an UEQM indication may be included in a common field of a UHR-SIG field, to indicate to all intended recipient STAs of the PPDU a common UEQM setting (indicating that UEQM is enabled for all recipient STAs or disabled for all recipient STAs). In another example, the UEQM indication may be included in the user field in the UHR-SIG field, so that the transmitting STA (e.g., an AP for DL) may include more than one user field in the UHR-SIG field. In this case, some user fields may have the UEQM Indication field set to “UEQM enabled” and some user fields may have the UEQM Indication field set to “UEQM disabled”, enabling a hybrid operation mode where a PPDU may have both UEQM and EQM.

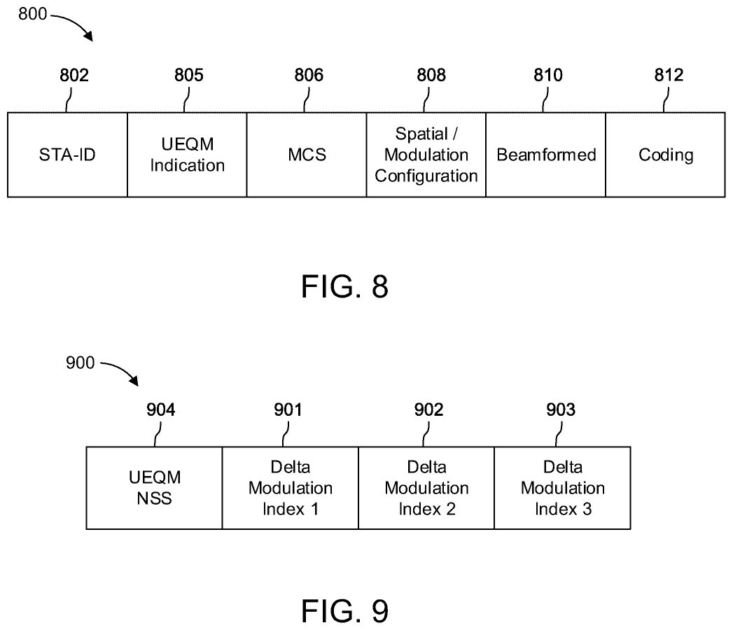

FIG. 8 is a frame format diagram illustrating an example user field 800 format for RUs/MRUs with EQM and UEQM, which may be included in a UHR PPDU. The user field 800 may include, but is not limited to include, any of the following fields: STA-ID subfield 802 may indicate the identity of a STA; UEQM indication subfield 805 may indicate if UEQM is enabled for the STA identified by the STA-ID; MCS subfield 806 (described below); spatial/modulation configuration field 808 (described below); beamformed subfield 810 may indicate whether beamforming or precoding is applied on the assigned RU/MRU; and/or coding subfield 812 may indicate the coding scheme (e.g., BCC or LDPC).

MCS subfield 806 may indicate the modulation and coding scheme for the indicated STA if UEQM is disabled. If UEQM is enabled, MCS subfield 806 may indicate the coding rate for all spatial streams. MCS subfield 806 may indicate the modulation scheme for one spatial stream (e.g., the spatial stream with highest modulation order or the spatial stream with the lowest modulation order). In an example, MCS subfield 806 may indicate the flooring or ceiling of the average modulation order among all the spatial/spatial streams.

Spatial/modulation configuration subfield 808 may indicate the number of spatial/spatial streams for the STA identified by the STA-ID, and the modulation order corresponding to the spatial/spatial stream other than that signaled in the MCS subfield. The Spatial/Modulation Configuration subfield may be in the format of a lookup table. An example is shown in Table 1. Note more or less entries may be possible. Mk in Table 1 refers the modulation index for the kth data/spatial stream. When two stream is indicated, k could be 1 or 2. When three stream is indicated, k could be 1 or 2 or 3. When four stream is indicated, k could be 1 or 2 or 3 or 4. In this example, M1 is signaled or can be derived from MCS subfield. The modulation index may be defined as follows. The modulation index may be 0 for BPSK modulation. The modulation index may be 1 for QPSK modulation. The modulation index may be 2 for 16QAM modulation. The modulation index may be 3 for 64QAM modulation. The modulation index may be 4 for 256QAM modulation. The modulation index may be 5 for 1024QAM modulation. The modulation index may be 6 for 4096QAM modulation. The transmitter may guarantee that after the plus or minus operation shown in Table 1, the resulted modulation indices are valid values (e.g., in the range of [0,6] in above example). If at least one resulting modulation index is invalid, then the receiving STA may consider the PPDU is not valid or the SIG field is corrupted.

TABLE 1
Example Spatial/Modulation Configuration field design

| Values | Meaning |
|---|---|
| 0 | two data stream and M2 = M1 + 1 or M2 = M1 − 1 |
| 1 | two data stream and M2 = M1 + 2 or M2 = M1 − 2 |
| 2 | two data stream and M2 = M1 + 3 or M2 = M1 − 3 |
| 3 | two data stream and M2 = M1 + 4 or M2 = M1 − 4 |
| 4 | three data stream and M2 = M1; M3 = M1 + 1 or M3 = |
| | M1 − 1; |
| 5 | three data stream and M2 = M1 + 1 or M2 = M1 − 1; M3 = |
| | M1 + 2 or M3 = M1 − 2; |
| 6 | three data stream and M2 = M1 + 1 or M2 = M1 − 1; M3 = |
| | M1 + 3 or M3 = M1 − 3; |
| 7 | three data stream and M2 = M1 + 2 or M2 = M1 − 2; M3 = |
| | M1 + 3 or M3 = M1 − 3; |
| 8 | four data stream and M2 = M1; M3 = M1 + 1 or M3 = |
| | M1 − 1; M4 = M1 + 2 or M4 = M1 − 2 |
| 9 | four data stream and M2 = M1; M3 = M1 + 2 or M3 = |
| | M1 − 2; M4 = M1 + 3 or M4 = M1 − 3 |
| 10 | four data stream and M2 = M1 + 1 or M2 = M1 − 1; M3 = |
| | M1 + 2 or M3 = M1 − 2; M4 = M1 + 3 or M4 = M1 − 3 |
| 11 | four data stream and M2 = M1 + 2 or M2 = M1 − 2; M3 = |
| | M1 + 3 or M3 = M1 − 3; M4 = M1 + 4 or M4 = M1 − 4 |
| . . . | . . . |

In another example, a UEQM operation may be limited by the number of spatial streams. For example, UEQM may be allowed for 2 and 4 spatial streams cases. In this scenario, a spatial/modulation configuration subfield format may be used as shown in FIG. 9. FIG. 9 is a frame format diagram illustrating an example spatial/modulation configuration subfield 900 format that may be included in a user field of a PPDU (e.g., the user field 800 of FIG. 8). The example spatial/modulation configuration subfield 900 may include, but is not limited to include, the following fields: UEQM NSS subfield 904, Delta Modulation Index 1 subfield 901, Delta Modulation Index 2 subfield 902, and Delta Modulation Index 3 subfield 903.

UEQM NSS subfield 904 may indicate the number of spatial stream for the UEQM operation. For example, the subfield may be set to a first value to indicate 2 spatial streams, and a second value to indicate 4 spatial streams. Delta modulation index 1 subfield 901 may indicate the modulation index difference between the base modulation index signaled by the MCS subfield and the second modulation index. Here the base modulation index may be used for the first spatial stream and the second modulation index may be used for the 2nd spatial stream. For example, delta modulation index 1=base modulation index-modulation index for spatial stream 2. Delta Modulation Index 2 subfield 902 may indicate the modulation index difference between the base modulation index signaled by the MCS subfield and the third modulation index. Here the third modulation index may be used for the 3nd spatial stream. For example, delta modulation index 2=base modulation index-modulation index for spatial stream 3. In another example, the delta modulation index 2 subfield 902 may indicate the modulation index difference between the second modulation index and the third modulation index. For example, delta modulation index 2=modulation index for spatial stream 2-modulation index for spatial stream 3. The delta modulation index 2 subfield 902 may be reserved when the UEQM NSS subfield 904 indicates 2 spatial streams.

Delta Modulation Index 3 subfield 903 may indicate the modulation index difference between the base modulation index signaled by the MCS subfield and the fourth modulation index. Here the fourth modulation index may be used for the 4nd spatial stream. For example, delta modulation index 3=base modulation index-modulation index for spatial stream 4. In another example, the Delta Modulation Index 3 subfield may indicate the modulation index difference between the third modulation index and the fourth modulation index. For example, delta modulation index 3=modulation index for spatial stream 3-modulation index for spatial stream 4. Th delta modulation index 3 subfield 903 may be reserved when the UEQM NSS subfield indicates 2 spatial streams.

In another example, a user field with UEQM and without UEQM may present concurrently within a PPDU. For example, the transmitting STA (e.g., AP) may group the UEQM STAs together. The AP may allocate contiguous RU/MRUs to the UEQM group. The AP may have contiguous user fields for the UEQM STAs. For example, the AP may have the first (or last) N User fields for the UEQM STAs. In an example, N may be signaled in the U-SIG field or common field of the UHR-SIG field.

In an example, additional paddings may be added to UHR-SIG field to allow receiving STAs more time to process SIG information or allow multiple PPDUs with different PHY version to be aggregated in an A-PPDU. In an example, a user field with specific STA-ID value may be used to add padding bits. A receiving STA may not need to decode the user field with padding bits.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A first station (STA) comprising:
a transceiver; and
a processor,
wherein the transceiver and processor are configured to:
receive a physical protocol data unit (PPDU) comprising a signal (SIG) field, the SIG field comprising a plurality of user fields associated with a respective plurality of spatial streams of a plurality of stations (STAs), each of the plurality of user fields including: an indication of a STA identifier (ID) of a respective STA, an indication of a spatial stream of the respective STA, and an indication of a modulation and coding scheme (MCS) of the respective spatial stream of the respective STA;
determine, based on the indicated STA IDs in the plurality of user fields, one or more user fields intended for the first STA, wherein a number of the one or more user fields intended for the first STA corresponds to a number of spatial streams of the first STA;
determine, for each of the spatial streams of the first STA, an MCS value based on the indicated MCS in the user field intended for the first STA for the respective spatial stream according to the spatial stream indication; and
decode the spatial streams for the first STA according to the determined MCS values using one or more resource units (RUs) or multiple resource units (MRUs).

2. The first STA of claim 1, wherein the plurality of user fields comprise:
a first user field that indicates the first STA, a first spatial stream of the first STA, and a first MCS associated with the first spatial stream of the first STA; and
a second user field that indicates the first STA, a second spatial stream of the first STA, and a second MCS associated with the second spatial stream of the first STA, wherein the first MCS associated with the first spatial stream of the first STA and the second MCS associated with the second spatial stream of the first STA include different modulation orders.

3. The first STA of claim 2, wherein the plurality of user fields further comprise:
a third user field that indicates a second STA, a first spatial stream of the second STA, and a first MCS associated with the first spatial stream of the second STA; and
a fourth user field that indicates the second STA, a second spatial stream of the second STA, and a second MCS associated with the second spatial stream of the second STA, wherein the first MCS associated with the first spatial stream of the second STA and the second MCS associated with the second spatial stream of the second STA include different modulation orders.

4. The first STA of claim 1, wherein the PPDU further comprises a U-SIG field, wherein the SIG field or the U-SIG field comprise an indication that unequal modulation (UEQM) is enabled.

5. The first STA of claim 1, wherein the PPDU further comprises a common field comprising an RU allocation field, wherein the RU allocation field includes an indication of an RU allocation of the one or more RUs or MRUs and indication of a number of user fields associated with the RU allocation.

6. The first STA of claim 1, wherein the PPDU further comprises: legacy short training field (L-STF) field, legacy long training field (L-LTF) field, legacy signal (L-SIG) field, repeated L-SIG (RL-SIG) field, universal signal (U-SIG (field, short training field (STF) field, a plurality of long training field (LTF) fields, data field and packet extension (PE) field.

7. The first STA of claim 1, wherein the first STA has multiple spatial streams and accordingly multiple associated user fields in the plurality of user fields.

8. The first STA of claim 1 configured as a non-access point (non-AP) STA, wherein the PPDU is received from an AP.

9. The first STA of claim 1 configured as an access point (AP), wherein the PPDU is received from a non-AP STA.

10. The first STA of claim 1, wherein the PPDU is an 802.11bn ultra high reliability (UHR) PPDU.

11. A method performed by a first station (STA), the method comprising:
receiving a physical protocol data unit (PPDU) comprising a signal (SIG) field, the SIG field comprising a plurality of user fields associated with a respective plurality of spatial streams of a plurality of stations (STAs), each of the plurality of user fields including: an indication of a STA identifier (ID) of a respective STA, an indication of a spatial stream of the respective STA, and an indication of a modulation and coding scheme (MCS) of the respective spatial stream of the respective STA;
determining, based on the indicated STA IDs in the plurality of user fields, one or more user fields intended for the first STA, wherein a number of the one or more user fields intended for the first STA corresponds to a number of spatial streams of the first STA;
determining, for each of the spatial streams of the first STA, an MCS value based on the indicated MCS in the user field intended for the first STA for the respective spatial stream according to the spatial stream indication; and
decoding the spatial streams for the first STA according to the determined MCS values using one or more resource units (RUs) or multiple resource units (MRUs).

12. The method of claim 11, wherein the plurality of user fields comprise:
a first user field that indicates the first STA, a first spatial stream of the first STA, and a first MCS associated with the first spatial stream of the first STA; and
a second user field that indicates the first STA, a second spatial stream of the first STA, and a second MCS associated with the second spatial stream of the first STA, wherein the first MCS associated with the first spatial stream of the first STA and the second MCS associated with the second spatial stream of the first STA include different modulation orders.

13. The method of claim 12, wherein the plurality of user fields further comprise:
a third user field that indicates a second STA, a first spatial stream of the second STA, and a first MCS associated with the first spatial stream of the second STA; and
a fourth user field that indicates the second STA, a second spatial stream of the second STA, and a second MCS associated with the second spatial stream of the second STA, wherein the first MCS associated with the first spatial stream of the second STA and the second MCS associated with the second spatial stream of the second STA include different modulation orders.

14. The method of claim 11, wherein the PPDU further comprises a U-SIG field, wherein the SIG field or the U-SIG field comprise an indication that unequal modulation (UEQM) is enabled.

15. The method of claim 11, wherein the PPDU further comprises a common field comprising an RU allocation field, wherein the RU allocation field includes an indication of an RU allocation of the one or more RUs or MRUs and indication of a number of user fields associated with the RU allocation.

16. The method of claim 11, wherein the PPDU further comprises: legacy short training field (L-STF) field, legacy long training field (L-LTF) field, legacy signal (L-SIG) field, repeated L-SIG (RL-SIG) field, universal signal (U-SIG (field, short training field (STF) field, a plurality of long training field (LTF) fields, data field and packet extension (PE) field.

17. The method of claim 11, wherein the first STA has multiple spatial streams and accordingly multiple associated user fields in the plurality of user fields.

18. The method of claim 11, wherein the first STA is configured as a non-access point (non-AP) STA, wherein the PPDU is received from an AP.

19. The method of claim 11, wherein the first STA is configured as an access point (AP), wherein the PPDU is received from a non-AP STA.

20. The method of claim 11, wherein the PPDU is an 802.11bn ultra high reliability (UHR) PPDU.
